(19) United States
(12) Patent Application Publication
(10) Pub. No.: US 2003/0069942 A1
(43) Pub. Date: Apr. 10, 2003

(54) System and method for localized internet domain names and addressing

(76) Inventor: Jackie Michael Bell, Key Largo, FL (US)

Correspondence Address: Jackie M. Bell, 817 LAPALOMA RAOD, KEY LARGO, FL, 33037, US

(21) Appl. No.: 10/265,920

(22) Filed: Oct. 7, 2002

Related U.S. Application Data
(60) Provisional application No. 60/345,470, filed on Oct. 9, 2001.

(51) Int. Cl. G06F 15/16

(52) U.S. Cl. 709/218; 709/219

(57) ABSTRACT

The present invention is a process and business of localizing Uniform Resource Identifiers (URI) or Uniform Resource Locators (URL) so to expand the available pool of descriptive domain names that can be registered and to fashion the Internet into an increasingly localized medium. The method would reserve one secondary host name field of a standard number of characters to be dedicated to a locality.

### BACKGROUND OF THE INVENTION

The Internet is a global network of connected computer networks (or intranets). Over the last several years, the Internet has grown in significant measure. A large number of computers on the Internet provide information in various forms. Anyone with a computer connected to the Internet can potentially tap into this vast pool of information.

The most wide spread method of providing information over the Internet is via the World Wide Web (the Web). The Web consists of a subset of the computers connected to the Internet; the computers in this subset run Hypertext Transfer Protocol (HTTP) servers (Web servers). The information available via the Internet also encompasses information available via other types of information servers such as GOPHER and FTP.

Information on the Internet can be accessed through the use of a Uniform Resource Locator (URL). A URL uniquely specifies the location of a particular piece of information on the Internet. A URL will typically be composed of several components. The first component typically designates the protocol by which the address piece of information is accessed (e.g., HTTP, GOPHER, etc.). This first component is separated from the remainder of the URL by a colon (‘:’). The remainder of the URL will depend upon the protocol component. Typically, the remainder designates a computer on the Internet by name, or by IP number, as well as a more specific designation of the location of the resource on the designated computer. For instance, a typical URL for an HTTP resource might be:

http://www.server.com/dir1/dir2/resource.htm

where http is the protocol, www.server.com is the designated computer and /dir1/dir2/resouce.htm designates the location of the resource on the designated computer.

The designated computer component of the URL, namely the www.server.com portion of the example above constitutes the Domain Name of the computer. This is the English like name, or handle, of the computer on the Internet. This name is translated into an IP address by a hierarchical network of Domain Name Resolution systems. The first step in a URL resolution is to convert the English Domain Name into an Internet Protocol address. Only after this conversion is performed for the requesting computer can that requesting computer connect to the destination computer.

Client software has evolved that allows users of computers connected to the Internet to access this information. Advanced clients such as Netscape's Navigator and Microsoft's Internet Explorer allow users to access software provided via a variety of information servers in a unified client environment. Typically, such client software is referred to as browser software.

The commercialization of the Internet, most notably the Web aspect of the Internet, and the resulting successes has made the provision of Domain Names very limited. Since the number of meaningful names for hundreds of millions of computers will be limited it would be desirable to find ways to further uniquely identify individual Domain Names in a manner that is easy to define and easy to remember. It is also desirable to construct domain names so that resources can be localized.

For definitive information on URL syntax and semantics, see “Uniform Resource Identifiers (URI): Generic Syntax and Semantics,” RFC 2396 [42] (which replaces RFCs 1738 [4] and RFC 1808 [11]). See also “Functional Recommendations for Internet Resource Locators” [RFC1736] and “Functional Requirements for Uniform Resource Names” [RFC1737].

### BRIEF SUMMARY OF THE INVENTION

The present invention is directed to a system and method for localizing domain names and the business thereof. The current form of the Internet host name is contained in a string of three components separated with a period or ‘dot’ which follows the protocol component of the Internet Universal Resource Locator (URL). For example the most common form of a URL is the world wide web service as in the in the following URL:

http://www.DomainName.com

the ‘http://’ component indicates that this is a world wide web address. The ‘DomanName.com’ component is the name of the computer that is held in the domain name registry, and the ‘com’ component of the URL indicates that this is a commercial domain name.

The Internet uses a number of different protocols for information transfer such as File Transfer Protocol, Gopher, ect.,etc. All of these protocols have the host name in common.

More exactly a domain name does not actually represent a single computer but a domain of computers usually associated with one business, institution, or governmental entity. The domain name can represent a single computer (host) or a number of computers (hosts). A single computer can even act as a host for a number of host names. In the scenario of multiple host names the domain name can be preceded by a number of dot separated human language identifiers. For instance www.DomainName.com could be HostOne.DomainName.com and would point to one host on the DomainName domain.

The ‘com’ component does allow the expansion of domain names by suffix. For instance, the same name ’DomainName’ can identify a number of different computers if it is followed by the suffix ‘org’ (organization), or ‘net’ (network), or ‘gov’ (restricted, government), or ‘edu’ (restricted, educational) or one of the many country specific suffixes.

The addressing of any computer on the internet is performed by a hierarchical addressing scheme. In reality each computer on the Internet which has a stable and unchanging address has a numerical identifier much like a telephone number. When a user types in a human language domain name this identifier must be “resolved” into a numbered address so that all communications can be directed to the target computer. There are different levels of address resolution. At the primary level the domain name is searched and once found the request for a number is directed to the hosting name server. The hosting name server then resolves the address and returns the required information to the original requester.

High level domain address servers are quasi official organization regulated by the United States Government. The secondary domain name servers a usually privately owned by large communications companies and Internet Hosting companies. The invention here proposes to insert a second regulated, either privately or by government, domain name layer that would break the domain name into an additional localized naming scheme as follows.

The present invention proposes to reorganize the segments of the URL to include a location segment of greater granularity than the current country code. For example, the domain name ‘ComputerName’ can be constructed as ‘www.ComputerName’ for a computer located anywhere in the world or ‘ny.ComputerName.com’ for a computer located in New York or ‘la.ComputerName’ for a computer located in Los Angeles. Alternatively domain names could take the form DomainName.us.ny as they do now for many government organizations. Regardless of the most useful method the approach would provide the following unique advantages.

This expands the domain names available to the general public. In essence most domain names would become available for use by localities. The popular name ‘ComputerRepair.com’ could be assigned to individuals in localities. For instance a computer repairperson in Jacksonville Fla. could register ‘jak.ComputerRepair.com’. While another such professional residing in San Francisco could register ‘sf.ComputerRepair.com’.

Web Browsers could accommodate localities by allowing the individual to choose a default locality that will be pre-pended to any domain name entered into the URL designation. In this manner if they were going to travel or were doing research on a particular locality they could limit their searches and links to organizations int hat area.

Large firms with nationally recognized names could use the localization method to offer products, services, and support on a local basis if they have offices physically located there.

All requests in a locality that are not prefixed are assumed to be in that locality. For instance, if a user in the ‘mia’ designated area entered ‘sports.com’ as a web address the name would be assumed to be ‘mia.sports.com’. This type of localization can increase the speed and efficiency of domain name addressing by allowing domain name servers on local networks and by faster routing of domain name requests to name servers.

Localization companies could license and own the domain name servers for their area and could profit from selling and maintaining domain names on that network. For example, a company in Miami Fla. could license the prefix ‘mia’. All domain name requests with the ‘mia’ prefix (‘mia.sports.com’, ‘mia.weather.com’, ‘mia.airlines.com’, ‘mia.travel.com’, etc. etc) would be routed directly to this server and it would then resolve the name.

Localities could be made as small as reasonable and logical expanding the names and business opportunities for a far greater number of people than does the existing domain name scenario. For example, Cutler Ridge is a suburb of Miami and so that small community could have a local sports web site named ‘mia.ctl.schools.com’. If the browser was set to local then just ‘schools.com’ or even ‘schools’ could give the user local school information for just that area.

Localized Domain names can be regulated and reserved in order to greatly increase the use of the Internet locally. For example all generally descriptive nouns like city, police, fire, or clerkofcourt would link directly to the organization that serves the locality. Plural or general nouns like families, schools, dogs, cars, shopping in the local domain would be reserved for regulation and would provide a place for all interested parties to apply a link to their organization if applicable.

This type of localization also facilitates the creation of the Internet into a node like system of physically connected smaller networks which would dramatically decrease the load on the national network created by high bandwidth applications like streaming media.

Localization in this manner would impose a sort of capitalist populism on the Internet especially if local domain name holders were required to have a physical address or business license in that locality.

### BRIEF DESCRIPTION OF THE SEVERAL VIEWS OF THE DRAWING

FIG. 1-1: Graphic representation of the User Host.

FIG. 1-2: Graphic representation of the ISP Domain Name Server.

FIG. 1-3: Graphic representation of the National Domain Name Server.

FIG. 1-4: Graphic representation of the Target ISP Domain Name Server.

FIG. 1-5: Graphic representation of the Target Host.

FIG. 2-6: Graphic representation of the User Host.

FIG. 2-7: Graphic representation of the Local Domain Name Server.

FIG. 2-8: Graphic representation of the Local Target Host.

FIG. 3-10: Graphic representation of User Host.

FIG. 3-11: Graphic representation of Local Physical Network.

FIG. 3-12: Graphic representation of Local Target Host.

FIG. 3-13: Graphic representation of Local Domain Name Server.

FIG. 3-14: Graphic representation of Target Local Domain Name Server.

FIG. 3-15: Graphic representation of Target Host.

### DETAILED DESCRIPTION OF THE INVENTION

A preferred embodiment of the invention is now described in detail. This embodiment would be organized and regulated under a public private joint licensing organization. One example could be an organization established between the inventor and the W3C organization. The inventor would establish guidelines for membership and would review and accept or deny local license applications. The W3C organization would promulgate protocols and standards. In this partnership each organization would receive some percentage each of the licensing fees.

Once W3C proposals for Localized Internet Name Addressing (LINA) were accepted by the governing regulating body the joint organization would begin to accept applications from local businesses to set up local addressing servers. Or, local addresses names may be allocated to existing addressing companies closest to that state.

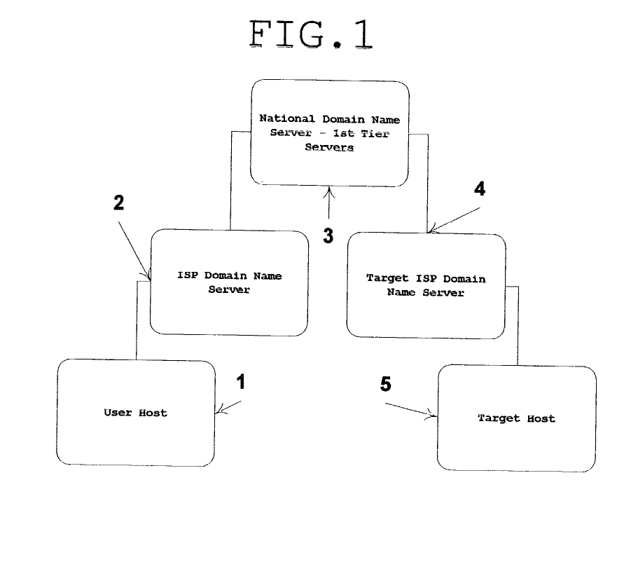

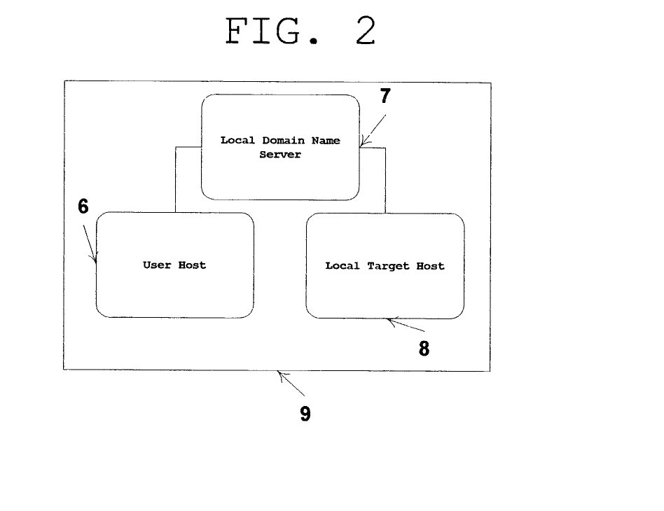

The current method for resolving domain name addresses is illustrated in FIG. 1 and detailed as follows.

1. The user host 1 requests the resolution of a domain name from the ISP domain name server 2.

2. The ISP domain name server 2 then requests from the national domain name server 3 the name of the target host ISP domain name server 5.

3. With the address the user ISP Domain Name server 2 requests the address the address for the name of the target host 5 on its' network.

The proposed process for accepting and resolving the domain names is as follows based on the preferred embodiment of the localized segment of the address being a prefix.

User Host 2 requests name resolution of ‘local.DomainName.com’ or simply ‘DomainName.com’. User Local Domain Name Server 7 which is located on the same physical network 9 as the User Host 6 finds the Target Host 8 address and returns it all activity being conducted on the local network 9. Thus if no prefix or suffix is supplied, as in ‘http://police’ the server 7 assumes a Local Target Host 8 and resolves the name locally.

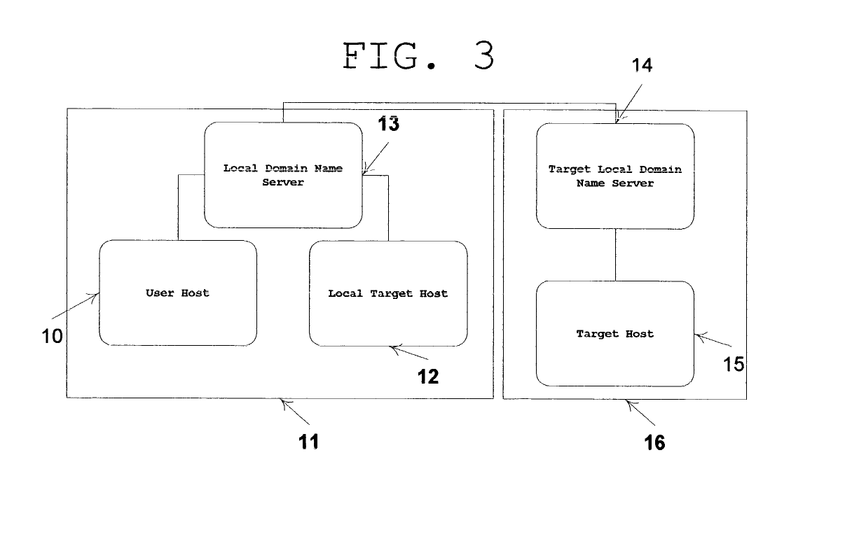

If another locality prefix is specified without suffix, illustrated in FIG. 3, such as ‘miami.police’, the Local Domain Name Server 13 requests the address resolution directly from the ‘miami’ Target Local Domain Name Server 14 and returns the resolved address to the User Host 10.

If no locality prefix is specified, such as ‘www.hello.com’ the name is resolved conventionally, i.e. by a request to the national name servers as illustrated in figure one and described above.

If the business, which is national, purchases by special agreement all of the local domain names then the entry of that name, such as ‘Microsoft’ would resolve to their local representative or to their national domain.

What is claimed is:

1. A method for organizing domain name address for use as dedicated or permanent local address to enhance localization and expand the available pool of domain names.

2. The method of claim 1, and further comprising the organization of name servers to achieve this end.

3. The methods of 1 and 2 and further comprising the business of registering and providing address resolution for localized domain names.
